(19) United States
(12) Patent Application Publication
(10) Pub. No.: US 2023/0256844 A1
(43) Pub. Date: Aug. 17, 2023

(54) Methods and Systems for Optimizing Parallel Charging

(71) Applicant: Yariv Glazer, Beer Tuvia (IL)

(72) Inventor: Yariv Glazer, Palo Alto, CA (US)

(21) Appl. No.: 18/109,150

(22) Filed: Feb. 13, 2023

Related U.S. Application Data
(60) Provisional application No. 63/310,091, filed on Feb. 14, 2022.

(51) Int. Cl. B60L 53/30; B60L 53/67; B60L 53/66; H02J 7/00; H02J 1/10

(52) U.S. Cl. CPC B60L 53/305; B60L 53/67; B60L 53/66; H02J 7/0013; H02J 1/106

(57) ABSTRACT

A system for parallel charging comprising: An electrical power source; a charging station management system; variable electric power switch controlled by the charging station management system; a charging device connected to the electrical power source via the variable electric power switch; an electrical power meter; a data channel for sending the measurement from the electrical power meter to the charging station management system; a battery powered device connected to the charging device via electrical power cable that is monitored by the electrical power meter; at least one other variable electric power switch controlled by the charging station management system. A method for enabling the system is also presented.

### PRIOR APPLICATION

This non-provisional utility application claims priority to the provisional patent application 63/310,091, filed Feb. 14, 2022.

### FIELD OF INVENTION

The present invention relates to a method and systems for optimizing parallel charging.

### BACKGROUND OF INVENTION

The invention is particularly useful with respect to charging multiple batteries with complex charging regiment, multiple types of batteries, Electric Vehicles (EV) charging stations, and multiple batteries with Battery Management Systems (BMS). The invention is therefore described below particularly with respect to such applications, but it will be appreciated that the invention could be used in many other applications involving charging multiple batteries in parallel.

Many techniques are known for charging multiple batteries at the same time by throttling power to a series of chargers, in order to handle the cumulative maximum power peaks of all the members in the series at the same time. Such known techniques generally limit the number of chargers to the maximum power that the electrical circuit support.

One drawback in the known techniques is when chargers in an array of chargers are connected to battery-powered devices at different times and with different charge level. In these situations, the load on the system is lower than the maximum capacity of the electric circuit which leads to loss of charging time and resources. The example above creates charging bottlenecks when the number of battery-powered devices exceeds the number of chargers, and the charging time window is narrow.

Another drawback in the prior art are situations where it may be desired to charge multiple batteries powered devices in a very short time. Such situation may be when the batteries powered devices are electric vehicles (EVs) and the charging array is a charging station connected to an electricity grid. The number of chargers is limited by the cumulated maximum power that chargers need to charge EVs at the same time. When an EV finish charging, its charger draws very little power from the grid and the grid utilization goes down, loosing time to charge more electric vehicles.

More drawbacks in the prior art stems from the use of Alternating Current (AC) as the power source of chargers. Level 3 charging standards requires Direct Current (DC) connection to electric vehicles batteries. In this configuration the electrical circuit have to include an AC/DC apparatus in order to convert the Alternating Current (AC) to Direct Current (DC). The efficacy of AC/DC apparatus is less than perfect which cause energy losses, generally to heat. In Charging station environments, that heat needs to be dispersed, which cause more energy losses. Avoiding such conversion will redirect the energy to charge more electric vehicles.

### SUMMARY OF THE INVENTION

This summary is intended to disclose the present invention, a method and system for optimizing parallel chargers. The embodiments and descriptions are used to illustrate the invention and its utility, and are not intended to limit the invention or its use. An object of the present invention is to provide a method, a system, and an apparatus, for charging multiple batteries in parallel in a manner having advantages in one or more of the above respects.

A system of parallel charging comprising: An electrical power source; a charging station management systems (CSMS); variable electric power switch controlled by the charging station management systems (CSMS); a charging device connected to the electrical power source via the variable electric power switch; an electrical power meter; a data channel for sending the measurement from the electrical power meter to the charging station management systems (CSMS); a battery powered device connected to the charging device via electrical power cable that is monitored by the electrical power meter; at least one other variable electric power switch controlled by the charging station management systems (CSMS); at least one other charging device connected to the electrical power source via the other variable electric power switch; at least one other electrical power meter; at least one other data channel for sending the measurement from the other electrical power meter to the charging station management systems (CSMS); at least one other battery powered device connected to the other charging device via at least one other electrical power cable that is monitored by the other electrical power meter; characterized in that the charging station management systems (CSMS) further comprises a processor to determine, based on the power measurement, the level of electrical power that the other variable electric power switch should allow to the other battery powered device connected to the other charging device and the charging station management systems (CSMS) turn on the other variable electric power switch to the level of electrical power allowed. The charging station management system (CSMS) comprises a first processor and a first non-transitory memory element; and a first computer-readable, non-transitory instruction set resident on the first non-transitory memory element.

In electric vehicles, the variable power switch is contained in the battery management system, and the charging station management system (CSMS) communicates the power draw limit to the vehicle using protocols such as the Open Charge Point Protocol (OCPP). In Lithium batteries, the variable power switch can be effectuated using transistors or connecting and disconnecting individual battery packs according to the approved power level read by the power meter. In other applications, the variable power switch can be effectuated with variable resistance schemes.

Some described embodiments include a battery, battery management system (BMS), or inconsistent power source such as solar panels, wind turbines, or a generator. In the example where the power source is a battery, the power source may be the battery of another electric vehicle. Such battery may also be mounted of another roadside assistance vehicle for assisting electric vehicles that got stranded along a highway. While fast charging requires Direct Current (DC), charging from a battery, regardless of charging station battery or electric vehicle battery, reduce the complexity of the electrical circuit which reduce energy loss and enable more charges to be completed.

Some described embodiments include a Charging Network Management System (CNMS) to direct electric vehicles to charging stations down the road and will ensure availability of fast charging slot at the time of arrival. The Charging Network Management System (CNMS) also provide charging network load balancing and help charging networks to cope with fluctuations in wind and solar energy production.

The invention is particularly useful to optimize parallel high-power charging from limited power source. For example, whereupon first electric vehicle battery is connected to charger port and draw 350 kW from a 500 kW power source, a first power meter continuously monitors the electrical power that the first electric vehicle battery draws. Soon after, a second electric vehicle battery get connected to a second charger port of the same power source, the second electric vehicle battery notifies Energy Management System (EMS) of the Charging Station that it charging profile support up to 350 kW power. Energy Management System (EMS) approve an initial charging limit of only 150 kW on the second charger port while a second power meter continuously monitors the electrical power that the second electric vehicle battery draws. As soon as the first power meter indicate that first electric vehicle battery power draw goes below 150 kW, Energy Management System (EMS) increase the charging power of second charger port to 350 kW.

The invention is also useful for directing traffic within a network of charging stations, specifically when there are charging stations with inconsistent power source such as wind turbines and solar. In such an application, a Charging Network Management System (CNMS) communicate via a communication channel with the Charging Station Management Systems (CSMS) of the charging stations in the network to select an available charging timeslot for a requesting electric vehicle. When such a network spans along highways, electric vehicles will be able to charge miles away from busy charging stations.

The invention is particularly advantageous with respect to charging stations with multiple power sources which include grid connection and local solar power generation (such as photo voltaic cells). In this situation the invention Energy Management Systems (EMS) select from which power source the battery of the charging station will be charged and when to combine the power sources in order to charge more vehicles at busy hours.

The invention is also useful for when using fast Direct Current (DC) charging. In this respect, the Charging Station Management Systems (CSMS) takes advantage of the charging profile to select different timeslots for the profile power peaks in order to maximize the power use.

Yet more embodiments describe off grid charging stations with a local solar power generation (such as photo voltaic cells) and an energy storage system such as butteries. In these described embodiments, an off grid charging station may be constructed at farms, remote locations, and disaster areas. When farmers acquire electric trucks, tractors, or other farm equipment, the challenge of energizing such equipment at the field become limiting factor for deployment. Having an off grid charging station constructed in accordance with the present invention, enables such remote users to operate electrical equipment and vehicles independent of electrical grid services.

The invention is particularly advantageous with respect to quick-deployed off-grid charging stations. Such charging stations may include a local solar power generation (such as photo voltaic cells), an energy storage system such as butteries, and an Energy Management Systems (EMS) for maintaining quality of service. A quick-deployed off-grid charging stations constructed according to the present invention may be folded to fit a pickup truck, a trailer, or a truck. Each part of the quick-deployed off-grid charging stations may be extended to increase the power generation capacity, the energy storage capacity, and the number of vehicles that can be charged in parallel.

Further features and advantages of the invention will be apparent from the description below.

### BRIEF DESCRIPTION OF THE DRAWINGS

The present invention is illustrated with 15 drawings on 15 sheets.

FIG. 1 is block diagram of a charging station constructed in accordance with the invention.

FIG. 2 is a flow chart illustrating a method of implementing the system of FIG. 1.

FIG. 3 is a block diagram illustrating network of charging stations constructed in accordance with the invention.

FIG. 4 is a flow chart illustrating a preferred method for implementing the system of FIG. 3.

FIG. 5 is a block diagram illustrating charging station with multiple power sources constructed in accordance with the invention.

FIG. 6 is a flow chart illustrating a method of operation of the system shown in FIGS. 3 and 5.

FIG. 7 is a flow chart illustrating a method of operation of the system shown in FIGS. 3 and 5.

FIG. 8 is a charging profile of a battery charged from a 350 kW DC supercharger.

FIG. 9 illustrates a system for optimizing multiple charging profiles using multiple 350 kW DC superchargers.

FIG. 10 is a flow chart illustrating a method of implementing the system of FIG. 9 using the profile of FIG. 8.

FIG. 11 is a system diagram illustrating a mobile charging station constructed in accordance with the invention.

FIG. 12 is a flow chart illustrating a method for implementing the system in FIG. 11.

FIG. 13 is a flow chart illustrating examples of operation of the system in FIG. 11.

FIG. 14 is a system diagram of a stand-alone charging station using a solar panel.

FIG. 15 is a flow chart illustrating a preferred method of implementing the system in FIG. 14.

### DETAILED DESCRIPTION OF THE DRAWINGS

The following descriptions are not meant to limit the invention, but rather to add to the summary of invention, and illustrate the present invention, by offering and illustrating various embodiments of the present invention, a method and system for optimizing parallel chargers. While embodiments of the invention are illustrated and described, the embodiments herein do not represent all possible forms of the invention. Rather, the descriptions, illustrations, and embodiments are intended to teach and inform one skilled in the art without limiting the scope of the invention.

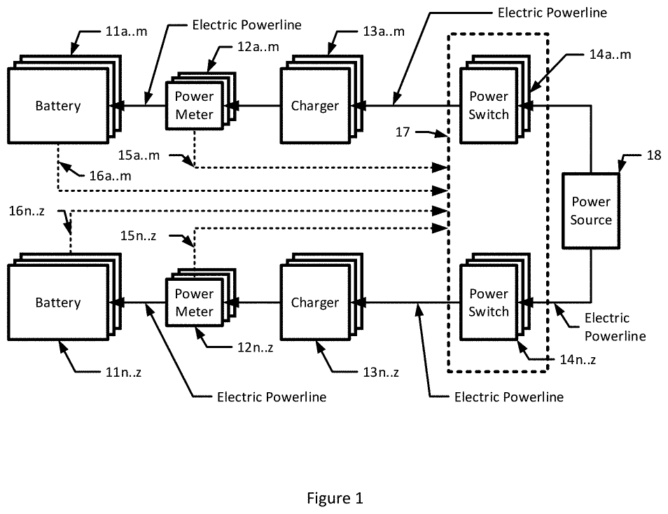

As shown in FIG. 1, the system is comprised of an electrical power source 18 feeding an electrical power using multiple electrical powerlines to a plurality of chargers 13a-13z via a plurality of variable power switches 14a-14z. The system also includes a charging station management systems (CSMS) 17 controlling plurality of variable power switches 14a-14z. Each of the plurality of chargers 13a-13z is capable of feeding electrical power to a battery 11a-11z via a power meter 12a-12z. Each power meter sends power measurements, via a communication channels 15a-15z, to the charging station management systems (CSMS) 17. Each battery also is connected via communication channel 16a-16z to charging station management systems (CSMS) 17 for communicating charging information.

In electric vehicles, the variable power switch 14a-14z is contained in the vehicle battery management system, and the charging station management system (CSMS) communicates the power draw limit to the vehicle using protocols such as the Open Charge Point Protocol (OCPP). In Lithium batteries, the variable power switch 14a-14z can be effectuated using transistors or connecting and disconnecting individual battery packs according to the approved power level read by the power meter. In other applications; the variable power switch 14a-14z can be effectuated with variable resistance schemes.

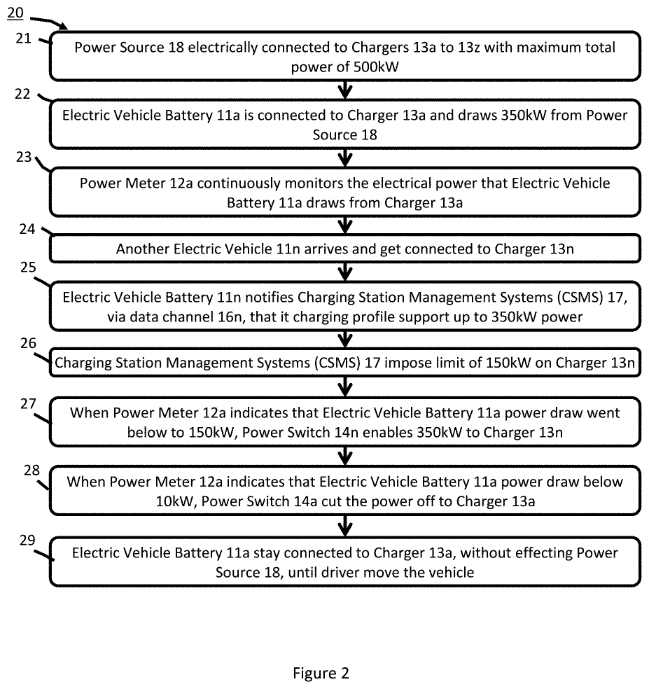

The flow chart in FIG. 2 illustrates one embodiment of the invention generally designated 20. In FIG. 2, power source 18 is electrically connected 21 to chargers 13a-13z with maximum total power of 500 kW; electric vehicle battery 11a is connected 22 to charger 13a and draws 350 kW, while power meter 12a continuously monitors 23 the electrical power that electric vehicle battery 11a draws from charger 13a. Another electric vehicle 11n arrives 24, gets connected to charger 13n, and notifies 25 the charging station management systems (CSMS) 17, via data channel 16n, that its charging profile supports up to 350 kW power. Due to the power limitation of power source 18, charging station management systems (CSMS) 17 imposes 26 a limit of 150 kW on charger 13n. When the power meter 12a indicates 27 that the electric vehicle battery 11a power draw goes down, the charging station management systems (CSMS) 17 instructs power switch 14n to gradually increase 27 the power up to 350 kW to charger 13n. As soon as the power meter 12a indicates 28 that the electric vehicle battery 11a power draw goes below 10 kW, power switch 14a cuts the power off to charger 13a while electric vehicle 11a stays connected 29 without effecting power source 18.

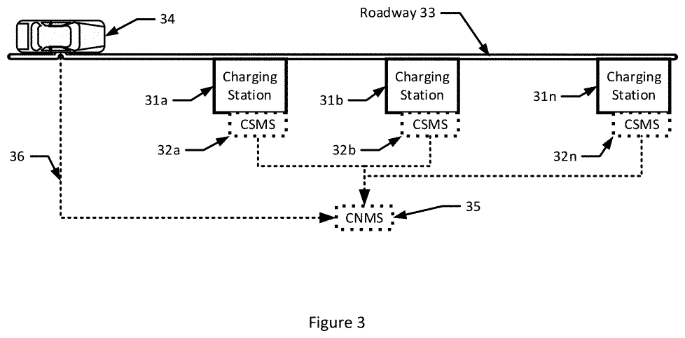

As shown in FIG. 3, the system includes a charging network management system (CNMS) 35, connected via data channels, to a plurality of charging station management systems (CSMS) 32a-32n, each located in a charging station 31a-31n at different locations along roadway 33. Along the roadway, electric vehicle 34 requesting charging using data channel 36, from charging network management system (CNMS) 35, a place to charge its battery. The charging network management system (CNMS) has a second processor; a second non-transitory memory element; and a second computer-readable, non-transitory instruction set resident on the second non-transitory memory element.

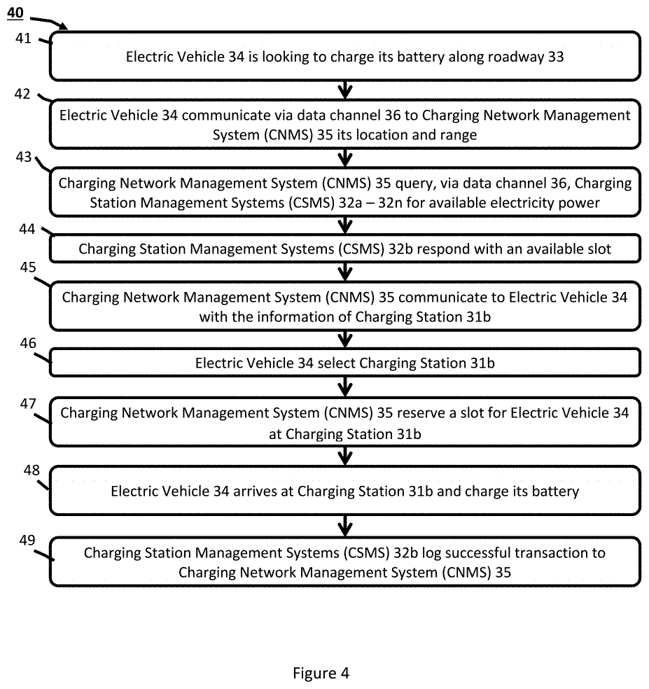

The flow chart in FIG. 4 illustrates a method of the invention shown in FIG. 3. In the diagram of FIG. 4, generally designated 40, an electric vehicle 34 is looking 41 to charge its battery along roadway 33; electric vehicle 34 communicate via data channel 36 to charging network management system (CNMS) 35 its location and range 42. Charging network management system (CNMS) 35 query, via data channel 36, charging station management systems (CSMS) 32a-32n for available electricity power 43, and charging station management systems (CSMS) 32b respond with an available slot 44. Charging network management system (CNMS) 35 communicate 45 to electric vehicle 34 with the information of charging station 31b, and electric vehicle 34 select 46 charging station 31b. Charging network management system (CNMS) 35 reserve 47 a slot for electric vehicle 34 at charging station 31b until electric vehicle 34 arrives 48 and charge its battery. When charge is complete, charging station management systems (CSMS) 32b log 49 successful transaction to charging network management system (CNMS) 35.

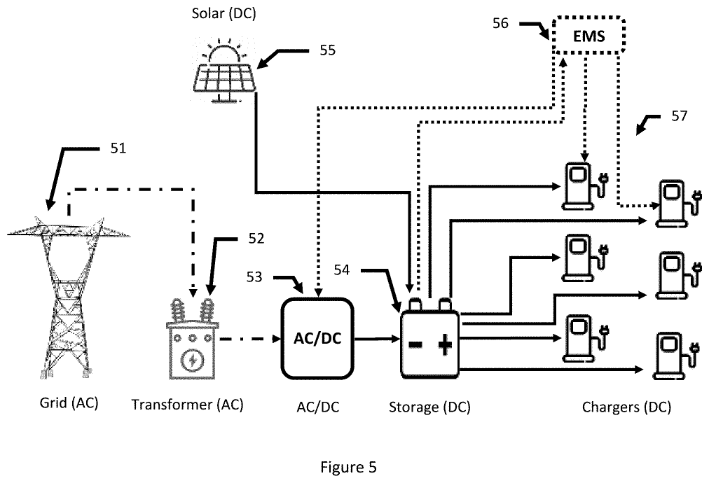

FIG. 5 shows an embodiment of the system that includes both grid connection 51 and solar generation components 55. At the center of this embodiment, there is a Direct Current (DC) storage 54, connected to two power sources. At the left of the diagram, storage 54 connected to an Alternating Current (AC) electricity grid 51 via transformer 52 and AC/DC converter 53 to convert the Alternating Current to Direct Current. DC Storage 54 also connected to a photovoltaic (solar) power source 55. An energy management system (EMS) 56 has been added to regulate and control the load of the electric power source. On the right side of the drawing there are DC superchargers 57, the consumers of power. Chargers 57, storage 54 and AC/DC 53 communicate with energy management system (EMS) 56 via data channel.

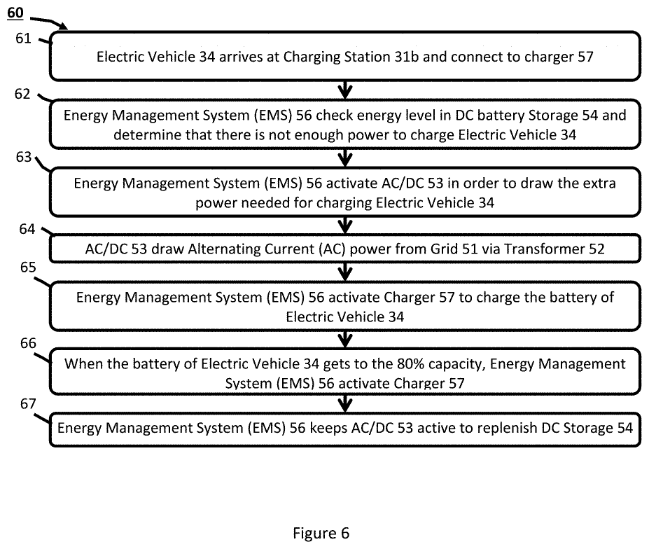

The flow chart in FIG. 6 illustrates a method of the invention shown in FIG. 3 and FIG. 5. In the flow diagram of FIG. 6, generally designated 60, an electric vehicle 34 arrives 61 at charging station 31b and connects 61 to charger 57. After energy management system (EMS) 56 checks 62 energy level in DC storage 54 and determines 62 that there is not enough power to charge electric vehicle 34, energy management system (EMS) 56 activates 63 AC/DC 53 in order to draw the extra power needed for charging electric vehicle 34. When AC/DC 53 draws 64 Alternating Current (AC) power from grid 51 via transformer 52, energy management system (EMS) 56 activates 65 charger 57 to charge the battery of electric vehicle 34. When the battery of electric vehicle 34 gets 66 to 80% capacity, energy management system (EMS) 56 deactivates the charger 57 while keeping AC/DC 53 active 67 to replenish DC Storage 54.

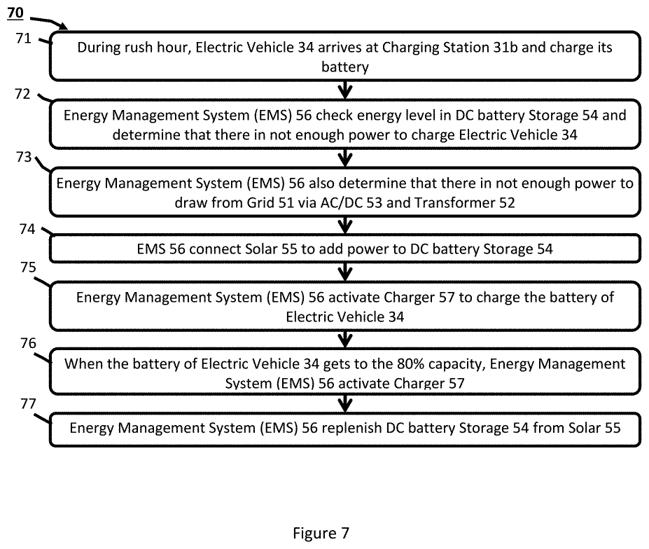

The flow chart in FIG. 7 illustrates a method of the invention shown in FIGS. 3 and 5. In FIG. 7, generally designated 70, an electric vehicle 34 arrives 71, during rush hour, to charging station 31b and connect to charger 57. After energy management system (EMS) 56 checks 72 energy level in DC storage 54 and determines 73 that there is not enough power in DC storage 54 and on the AC/DC 53 power circuit to charge electric vehicle 34, energy management system (EMS) 56 connects 74 Solar 55 to add power to DC battery Storage 54 in order to draw the extra power needed for charging electric vehicle 34. The energy management system (EMS) 56 activates 75 charger 57 to charge the battery of electric vehicle 34. When the battery of electric vehicle 34 reaches 80% capacity, the energy management system (EMS) 56 deactivates 76 Charger 57 while keeping solar 55 active 77 to replenish DC Storage 54.

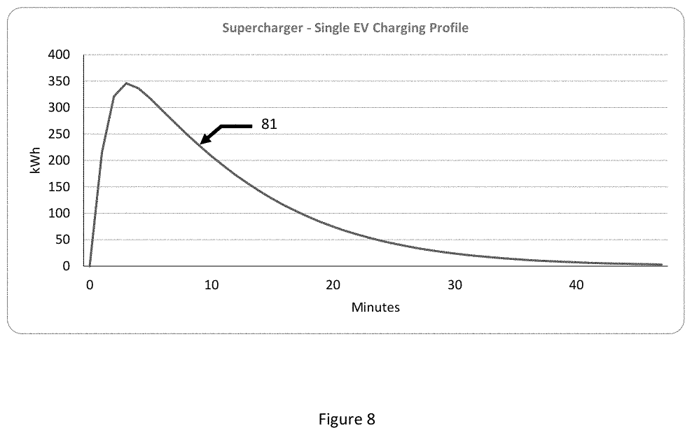

The charging profile 81 illustrated in FIG. 8 shows the power drawn by an electric vehicle battery when charging from a 350 kW DC supercharger.

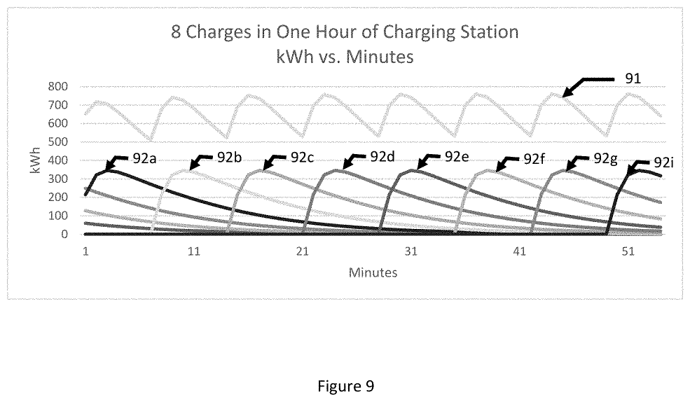

The chart in FIG. 9 illustrates a conservative timed optimized charging regiment 91 of a charging station with eight 350 kW DC superchargers 92a-92i.

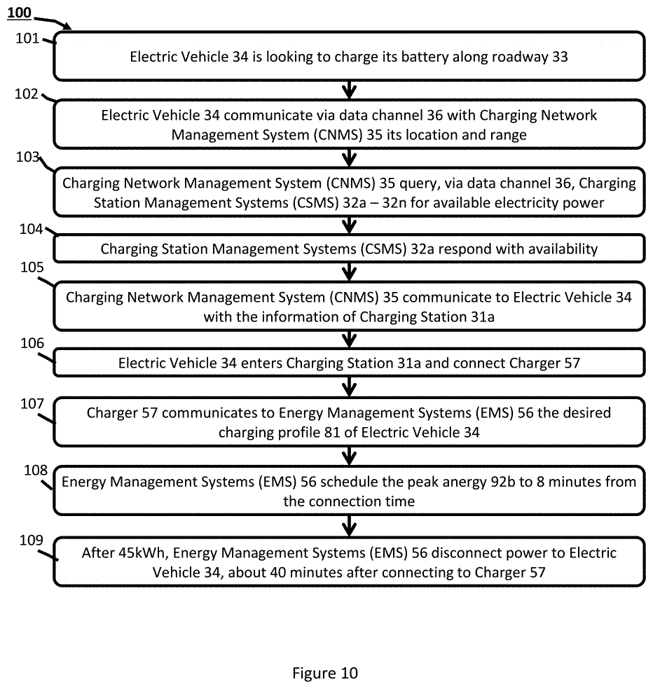

The flow diagram in FIG. 10 illustrates a method of the invention shown in FIG. 3, FIG. 8, and FIG. 9. In FIG. 10, generally designated 100, an electric vehicle 34 is looking 101 to charge its battery along roadway 33, communicates 102 via data channel 36 with charging network management system (CNMS) 35 its location and range. Charging network management system (CNMS) 35 queries 103, via data channel 36, charging station management systems (CSMS) 32a-32n for available electricity power. The charging station management systems (CSMS) 32a responds 104 with availability. After charging network management system (CNMS) 35 communicates 105 to electric vehicle 34 with the information of charging station 31a, electric vehicle 34 arrives 106 at charging station 31a and connects to charger 57. Charger 57 communicates 107 to energy management systems (EMS) 56 the desired charging profile 81 of electric vehicle 34, and energy management systems (EMS) 56 schedules 108 the peak energy 92b to 8 minutes from the connection time. After 45 kWh, energy management systems (EMS) 56 disconnects 109 power to electric vehicle 34, about 40 minutes after connecting to Charger 57.

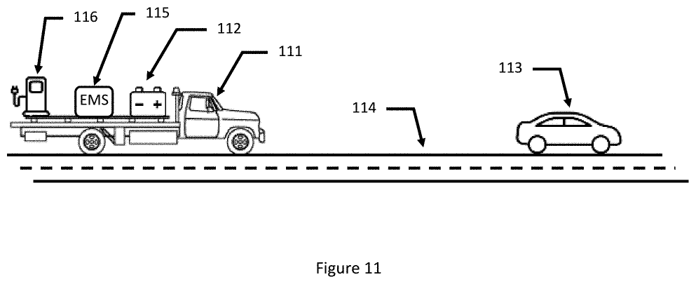

FIG. 11 shows yet another embodiment of the system that includes a mobile charging station 111. The diagram also illustrates key components of mobile charging station 111 such as electricity storage 112, energy management systems (EMS) 115, and chargers 116. The embodiment also illustrate roadway 114 along which mobile charging station 111 is positioned in order to charge electric vehicle 113.

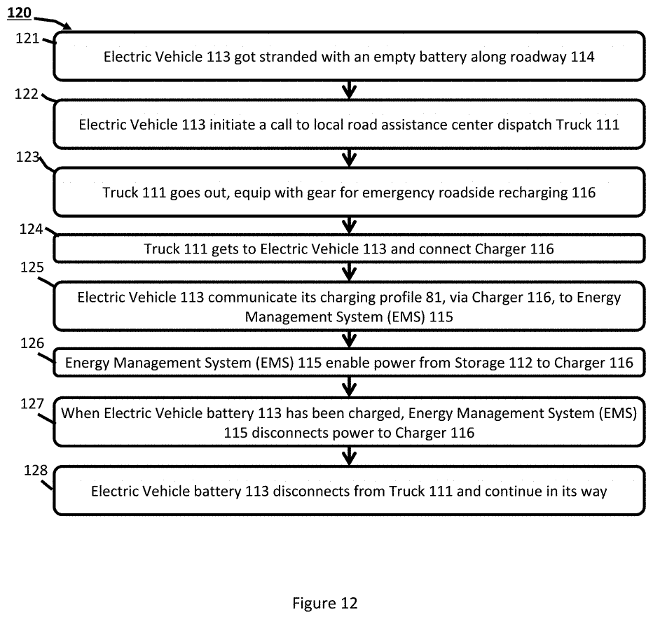

FIG. 12 is a flow diagram illustrating a method of the invention shown in FIG. 8 and FIG. 11. In FIG. 12, generally designated 120, an electric vehicle 113 gets stranded 121 with an empty battery along roadway 114, calling 122 local road assistance center to dispatch truck 111, equipped with gear for emergency roadside recharging. Truck 111 is dispatched 123 equipped with gear for emergency roadside recharging 116. When truck 111 gets 124 to electric vehicle 113 and connects 124 charger 116, electric vehicle 113 communicates 125 its charging profile 81, via charger 116, to energy management system (EMS) 115 that enable power 126 from storage 112 to charger 116. When the battery of electric vehicle 113 has been charged 127, energy management system (EMS) 115 disconnects 127 power to charger 116. Lastly, electric vehicle 113 disconnects 128 from Truck 111 and continue in its way.

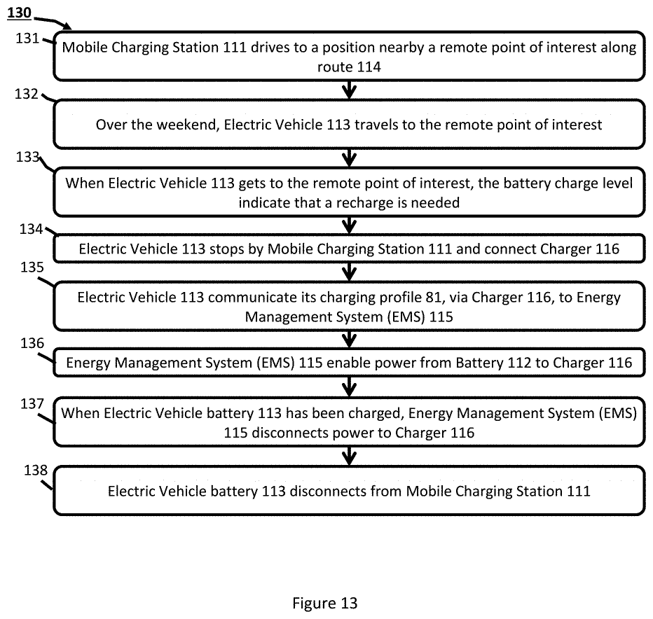

The flow chart in FIG. 13 illustrates a method of the invention shown in FIGS. 8 and 11. In FIG. 13, generally designated 130, Mobile charging station 111 drives 131 to a position nearby a remote point of interest along route 114. Electric vehicle 113 travels 132 to remote point of interest. When the electric vehicle 113 arrives at 133 the remote point of interest, its battery charge level indicates that a recharge is needed 133. Electric vehicle 113 goes to 134 mobile charging station 111, connects 134 to one of the chargers 116, and communicates 135 its charging profile 81 to energy management system (EMS) 115 to enable 136 power from storage 112 through charger 116. When the battery of electric vehicle 113 has been charged, energy management system (EMS) 115 disconnects 137 power from charger 116. Electric vehicle 113 disconnects 138 from mobile charging station 111.

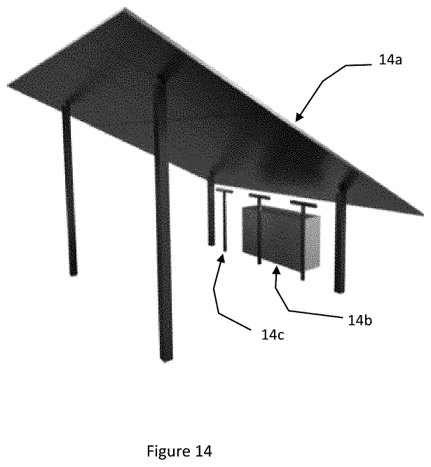

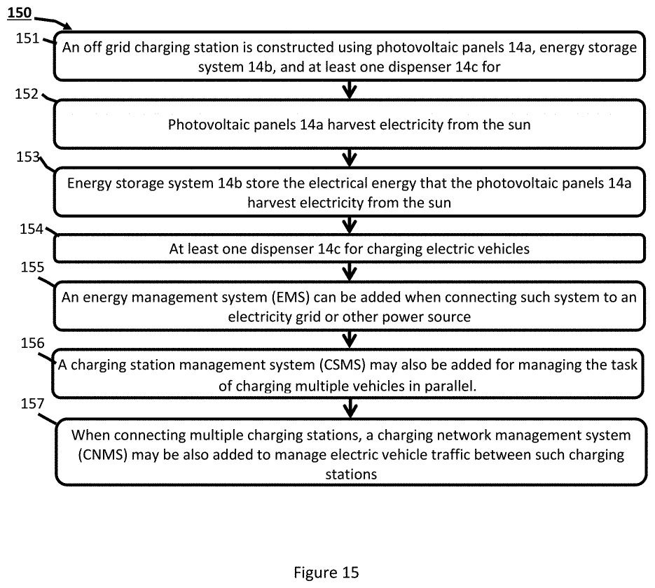

The flow chart in FIG. 15 illustrates an off-grid charging station method used with the system shown in FIG. 14. In FIG. 15, generally designated 150, an off-grid charging station is constructed 151 using photovoltaic panels 14a to harvest 152 electricity from the sun, energy storage system 14b to store 153 the electrical energy, and at least one dispenser 14c, connected to energy storage system 14b, for charging 154 electric vehicles. An energy management system (EMS) is optionally added 155 when connecting such system to an electricity grid or other power source. This embodiment may include a charging station management system (CSMS) for managing 156 multiple vehicles. When connecting multiple charging stations, a charging network management system (CNMS) may be also added 157 to manage electric vehicle traffic between such charging stations.

I claim:

1. A system of parallel charging comprising:
an electrical power source having a maximum output;
a first charging station management system;
a first plurality of variable electrical power switches;
a first plurality of chargers;
a first plurality of electrical powerlines;
a first plurality of power meters;
a first plurality of communications channels connected between the plurality of power meters and the charging management system; and
a first battery to be charged;
wherein the first battery is connected to a first charger through a first power meter;
wherein, when the first power meter transmits a power reading across a communication channel to the charging station management system, the charging station management system adjusts the first variable electrical power switch, connected to the first charger, so that the electrical power source feeds electrical power through a first electrical powerline to the variable electrical power switch and the first charger, charging the first battery; and
a second battery to be charged;
wherein the charging of the second battery begins after the first battery begins charging, but before the first battery is fully charged;
wherein the second battery is connected to a second charger through a second power meter;
wherein, when the second power meter transmits a power reading across a communication channel to the first charging station management system, the charging station management system adjusts the second variable electrical power switch, connected to the second charger, so that the electrical power source feeds electrical power through a second electrical powerline to the variable electrical power switch and the second charger, charging the second battery;
wherein the first and second variable electrical power switch are adjusted in real time by the first charging station management system, by monitoring the first and second power meter readings across the communications channels, so that the electrical power source does not exceed its maximum output.

2. The system of parallel charging in claim 1, further comprising a charging network management system.

3. The system of parallel charging in claim 2, further comprising
a second charging station management system;
a second plurality of variable electrical power switches;
a second plurality of chargers;
a second plurality of electrical powerlines;
a second plurality of power meters;
a second plurality of communications channels connected between the second plurality of power meters and the second charging management system; and
a third battery to be charged;
wherein the charging of the third battery begins after the first battery begins charging, but before the first battery is fully charged;
wherein the third battery is connected to a third charger through a third power meter;
wherein, when the third power meter transmits a power reading across a communication channel to the second charging station management system, the second charging station management system adjusts the third variable electrical power switch, connected to the third charger, so that the electrical power source feeds electrical power through a third electrical powerline to the variable electrical power switch and the third charger, charging the third battery; and
a fourth battery to be charged;
wherein the charging of the fourth battery begins after the first battery begins charging, but before the first battery is fully charged;
wherein the charging of the fourth battery begins after the third battery begins charging, but before the third battery is fully charged;
wherein, when the fourth power meter transmits a power reading across a communication channel to the second charging station management system, the second charging station management system adjusts the fourth variable electrical power switch, connected to the fourth charger, so that the electrical power source feeds electrical power through a fourth electrical powerline to the variable electrical power switch and the fourth charger, charging the fourth battery;
wherein the first, second, third, and fourth variable electrical power switch are adjusted in real time by the first charging station management system and the second charging station management system, by monitoring the first and second power meter readings across the communications channels, so that the electrical power source does not exceed its maximum output.

4. The system of parallel charging in claim 3, wherein the first plurality of chargers is located at a first location and wherein the second plurality of chargers is located at a second location, separate and apart from the first location.

5. The system of parallel charging in claim 4, wherein the charging network management system is connected to the first charging station management system; and wherein the charging network management system is connected to the second charging station management system.

6. The system of parallel charging in claim 5, wherein the first location and the second location are both located on common roadway.

7. The system of parallel charging in claim 6, wherein the first battery is in a first electric vehicle; wherein the second battery is in a second electric vehicle; wherein the third battery is in third electric vehicle; and wherein the fourth battery is in a fourth electric vehicle.

8. The system of parallel charging in claim 7, wherein the charging network management system has a communication channel through which one may make a query about the availability of chargers.

9. The system of parallel charging in claim 8, wherein the charging network management system can query both the first charging station management system and the second charging station management system, in real time, in order to ascertain the availability of chargers.

10. The system of parallel charging in claim 9, wherein a query is made to the charging network management system in order to charge a fifth battery in a fifth electric vehicle in the shortest amount of time.

11. The system of parallel charging in claim 10, wherein the charging network management system accesses its communication channels to the first charging station management system and the second charging station management system in order to obtain the current status of charging with respect to the first battery, the second battery, the third battery, and the fourth battery.

12. The system of parallel charging in claim 11, wherein the charging network management system schedules a charger for the fifth battery and communicates the same.

13. The system of parallel charging in claim 1, wherein the electrical power source is electricity provided from a grid.

14. The system of parallel charging in claim 1, wherein the electrical power source is solar harvested from photovoltaic cells.

15. The system of parallel charging in claim 1, wherein the electrical power source is at least one of electricity provided from a grid; harvested from photovoltaic cells; or stored in a battery storage system.

16. A method for parallel charging comprising the following steps:
connecting a power source having a maximum output to a first plurality of chargers through a first plurality of variable power switches;
monitoring in real time the power flowing to each of the first plurality of chargers with a first plurality of power meters;
connecting a first battery to a first charger from the first plurality of chargers;
monitoring the electrical power flowing to the first battery from the first charger by using a first power meter connected both to the first battery and the first charger;
connecting a second battery to a second charger from the first plurality of chargers, at a time after the first battery was connected to the first charger;
monitoring the electrical power flowing to the second battery from the second charger by using a second power meter connected both to the second battery and the second charger;
preventing the power flowing to the first charger and second charger from exceeding the maximum output.

17. The method for parallel charging of claim 16 wherein preventing the power flowing to the first charger and second charger from exceeding the maximum output is accomplished using the steps of
adjusting a first variable power switch from the first plurality of variable power switches, connected to the power source and the first charger, with a first charging station management system; and
adjusting a second variable power switch from the first plurality of variable power switches, connected to the power source and the second charger, with the first charging station management system.

18. The method of parallel charging of claim 17 wherein the first battery begins to draw less power as it approaches being fully charged.

19. The method of parallel charging of claim 18, further comprising the step of increasing the power flowing to the second battery by adjusting the second variable power switch.

20. The method of parallel charging of claim 17, wherein the power source is at least one of electricity provided from a grid; harvested from photovoltaic cells; or stored in a battery storage system.

21. The method of parallel charging of claim 20, further comprising the steps of
connecting the power source having a maximum output to a second plurality of chargers through a second plurality of variable power switches;
monitoring in real time the power flowing to each of the second plurality of chargers with a second plurality of power meters;
connecting a third battery to a third charger from the second plurality of chargers; at a time after the first battery was connected to the first charger;
monitoring the electrical power flowing to the third battery from the third charger by using a third power meter connected both to the third battery and the third charger;
connecting a fourth battery to a fourth charger from the second plurality of chargers, at a time after the first battery was connected to the first charger and at a time after the third battery was connected to the third charger;
monitoring the electrical power flowing to the fourth battery from the fourth charger by using a fourth power meter connected both to the fourth battery and the fourth charger;
preventing the power flowing to the first charger, second charger, third charger, and fourth charger from exceeding the maximum output.

22. The method for parallel charging of claim 21 wherein preventing the power flowing to the first charger, second charger, third charger, and fourth charger from exceeding the maximum output is accomplished using the steps of
adjusting the first variable power switch from the first plurality of variable power switches, connected to the power source and the first charger, with the first charging station management system;
adjusting the second variable power switch from the first plurality of variable power switches, connected to the power source and the second charger, with the first charging station management system;
adjusting a third variable power switch from the second plurality of variable power switches, connected to the power source and the third charger, with a second charging station management system.
adjusting a fourth variable power switch from the first plurality of variable power switches, connected to the power source and the fourth charger, with the second charging station management system.

23. The method for parallel charging of claim 22 comprising the further step of
using a charging network management system;
communicating between the first charging station management system and the charging network management system;
communicating between the second charging station management system and the charging network management system;
monitoring the power flowing to the first, second, third, and fourth battery using the charging network management system;
calculating the correct settings of the first, second, third, and fourth variable power switches, in order not to exceed the maximum output, using the charging network management system;
communicating from the charging network management system to the first charging station management system the correct settings for the first and second variable power switches; and
communicating from the charging network management system to the second charging station management system the correct settings for the third and fourth variable power switches.

24. The method of parallel charging of claim 23, wherein the first battery is contained in a first electric vehicle; the second battery is contained within a second electric vehicle; the third battery is contained in a third electric vehicle; and the fourth batter is contained in a fourth electric vehicle.

25. The method of parallel charging of claim 24, wherein the first plurality of chargers are located at a first location and the second plurality of chargers are located at a second location.

26. The method of parallel charging of claim 25, wherein the first location and the second location are both located on the same roadway, a first distance apart.

27. The method for parallel charging of claim 25 comprising the further step of
seeking a charger with which to charge fifth battery in a fifth electric vehicle;
querying the charging network management system to determine the availability of a charger;
determining the correct charger with which to charge the fifth battery by calculating the amount of time needed to get the fifth battery to each available charger; and
predicting the optimum charger for the fifth battery based on availability of charger, travel time to charger, and the amount of time needed to fully charge the fifth battery.

28. The method for parallel charging of claim 27 comprising the further step of scheduling a fifth charger selected from one of the first plurality of chargers and the second plurality of chargers with which to charge the fifth battery.

29. The method for parallel charging of claim 28, wherein the first charging station management system is comprised of a first processor; a first non-transitory memory element; and a first computer-readable, non-transitory instruction set resident on the first non-transitory memory element; wherein the second charging station management system is comprised a second processor; a second non-transitory memory element; and a second computer-readable, non-transitory instruction set resident on the second non-transitory memory element; and wherein the charging network management system is comprised of a third processor; a third non-transitory memory element; and a third computer-readable, non-transitory instruction set resident on the third non-transitory memory element.

30. The method for parallel charging of claim 28 comprising the further step using a power source comprised of electricity provided from a grid; electricity harvested from photovoltaic cells; and electricity stored in a battery storage system.

31. The method for parallel charging of claim 30 comprising the further step of
controlling the distribution of energy from the grid, photovoltaic cells, and storage by using the charging network management system to insure that the combined delivered power does not exceed the maximum output.

32. A mobile system of parallel charging comprising:
a vehicle;
an electrical power source having a maximum output, comprised of an energy storage device, mounted on the vehicle;
a charging station management system;
a plurality of variable electrical power switches;
a plurality of chargers;
a plurality of electrical powerlines;
a plurality of power meters;
a plurality of communications channels connected between the plurality of power meters and the charging management system; and
a first battery to be charged;
wherein the vehicle is dispatched to a remote location;
wherein the first battery is at the remote location and is connected to a first charger through a first power meter;
wherein, when the first power meter transmits a power reading across a communication channel to the charging station management system, the charging station management system adjusts the first variable electrical power switch, connected to the first charger, so that the electrical power source feeds electrical power through a first electrical powerline to the variable electrical power switch and the first charger, charging the first battery; and
a second battery to be charged;
wherein the second battery is at the remote location and is connected to a second charger through a second power meter;
wherein the charging of the second battery begins after the first battery begins charging, but before the first battery is fully charged;
wherein the second battery is connected to a second charger through a second power meter;
wherein, when the second power meter transmits a power reading across a communication channel to the charging station management system, the charging station management system adjusts the second variable electrical power switch, connected to the second charger, so that the electrical power source feeds electrical power through a second electrical powerline to the variable electrical power switch and the second charger, charging the second battery;
wherein the first and second variable electrical power switch are adjusted in real time by the charging station management system, by monitoring the first and second power meter readings across the communications channels, so that the electrical power source does not exceed its maximum output.
